(19) United States
(12) Patent Application Publication
(10) Pub. No.: US 2005/0178067 A1
(43) Pub. Date: Aug. 18, 2005

(54) Slider window assembly and method of fabrication thereof

(75) Inventors: Philippe Cusson, Saint-Nicolas (CA); Dany Boivin, Notre-Dame-Auxiliatrice de Buckland (CA)

Correspondence Address: QUARLES & BRADY LLP, 411 E. WISCONSIN AVENUE, SUITE 2040, MILWAUKEE, WI, 53202-4497, US

(73) Assignee: IPL, Inc.

(21) Appl. No.: 11/060,871

(22) Filed: Feb. 18, 2005

(30) Foreign Application Priority Data
Feb. 18, 2004 (CA) 2,458,424

(51) Int. Cl. B60J 1/16; E05F 11/38

(52) U.S. Cl. 49/413

(57) ABSTRACT

A slider window assembly, comprising a one-piece slider frame and seal assembly and a window panel mounted therein; the one-piece slider frame and seal assembly comprising a multi-material core and sheath parts, allowing an increased fabrication precision and therefore an improved water-tightness.

### CROSS REFERENCE TO RELATED APPLICATIONS

This application claims priority on Canadian patent application no 2,458,424 filed on Feb. 18, 2004, herein incorporated by reference.

### FIELD OF THE INVENTION

The present invention relates to window waterproof seals. More specifically, the present invention is concerned with a window waterproof seal and with a method of fabrication thereof.

### BACKGROUND OF THE INVENTION

Automotive sliders have been available on the market for many decades, for use on the back of pick up trucks for example, allowing an opening of a center glass window panel, generally by hand or by means of electrical motors, a motion of the glass window panel being either horizontal or vertical.

Currently, a standard fabrication method includes encapsulation of a fixed glass and metal extrusion of top and bottom rails inside a reaction in a mold (RIM) tool, the cavity of which being filled with a thermoset urethane (PU) or polyvinyl chloride (PVC) for example. This method yields robust slider seal frame assemblies. Since PU and PVC are materials with a hardness between about 85 and 95 shA, the resulting assemblies are able to withstand temperature variations, even cold temperatures, without suffering from stress forces that could lead to failure, as observed for example a few years ago in the case of injection molded encapsulation sliders made with rigid engineering thermoplastic materials.

However, this reaction in a mold (RIM) method is often labor intensive since it requires an extensive deflashing step of the molded parts after the molding step. Moreover, the slider needs to be assembled with the center glass window panel and sealing components that are usually glued onto the slider frame. Another issue is the fact that rejected parts from this reaction in a mold method are not recyclable and the cost of such rejects at the production level is non negligible. Another very important consideration is the quality of the resulting dynamic sealing system that seals the moving glass window panel from the exterior environment, since it appears that the water tightness is often very limited.

A number of methods for fabricating window waterproof seals allowing the window panel to be mobile between an open and a shut positions, hence the expression dynamic seal, have been developed.

For example, a first method includes extruding the different parts of the slider seal, cutting them out, and treating the specific parts thereof that are to be in contact with the mobile window panel with an antifriction coating, before finally assembling the parts in a window frame. However, in this first method, even when cutting the parts of the slider seal at an angle of 45° to form mitered corners, there is still a clearance or misfit between the parts when they are assembled in the window frame, which reduces a water tightness of the final assembly.

A second method similarly includes extruding the different parts of the slider seal and cutting them out. Then, in an over-moulding step, extremities of the cut parts of the slider seal are inserted into a mould and over-moulded in such a way as to be connected together. This second method, in contrast to the first one described hereinabove, allows achieving a slider seal that is continuous, even in the corners of the window frame. However, this method involves an increased number of steps, including the over-moulding step. Moreover, the quality of the slider seal is still dependent on the extrusion step, which is known as yielding tolerance problems and a reduced precision.

Therefore, there is still a need in the art for a slider window assembly and a method of fabrication thereof.

### SUMMARY OF THE INVENTION

There is provided a method for fabricating a window slider assembly, comprising the steps of molding a slider frame; molding slider sealing components about the slider frame to yield a one-piece multi-material slider frame and seal assembly; and assembling a window panel to the one-piece slider frame and seal assembly.

It is further provided a window slider assembly slider seal assembly comprising a one-piece slider frame and seal assembly and a window panel mounted therein, the one-piece slider frame and seal assembly comprising a slider frame and slider sealing parts molded in a multi-material mold, the slider frame being molded in a first material and the slider sealing parts being molded in a second material, the slider frame and seal assembly receiving at least one of a moving and a fixed window panel.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS BRIEF DESCRIPTION OF THE DRAWINGS

In the appended drawings:

FIG. 1 is a flowchart of a method according to a first aspect of the present invention;

FIG. 2 is an exploded front view of a slider frame and seal assembly of a slider window assembly according to an embodiment of a second aspect of the present invention;

FIG. 3 show cross sections of a slider frame and seal assembly for a center mobile window panel (FIGS. 3a) and 3b) and for a fixed window panel (FIG. 3c);

FIG. 4 illustrates a slider window assembly for a mobile window panel;

FIG. 5 show details of the mobile window panel of FIG. 4, with studs (a) and vertical edge tracks (b); and

FIG. 6 show a front view (a) and a rear (b) view of a slider window assembly according to the present invention.

### DESCRIPTION OF EMBODIMENTS OF THE INVENTION

There is provided a watertight slider window assembly and method of fabrication thereof.

The present method for fabrication of a watertight slider window assembly generally comprises a multi-material molding of a slider frame and of sealing components thereof, to yield a one-piece slider frame and seal assembly; and assembling a window panel to the resulting one-piece slider frame and seal assembly.

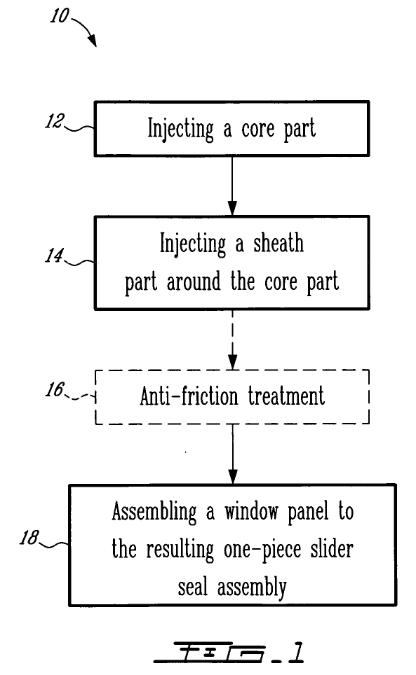

As shown in FIG. 1 of the appended drawings, the method 10 comprises molding a core part (step 12) and molding a sheath part around the core part (step 14), in a same mold. A further optional step 16 comprises submitting surfaces of the slider seal that are to be in contact with a mobile window panel to an anti-friction treatment. In step 18, a window panel, either mobile or fixed, is mounted to the resulting one-piece slider frame and seal assembly.

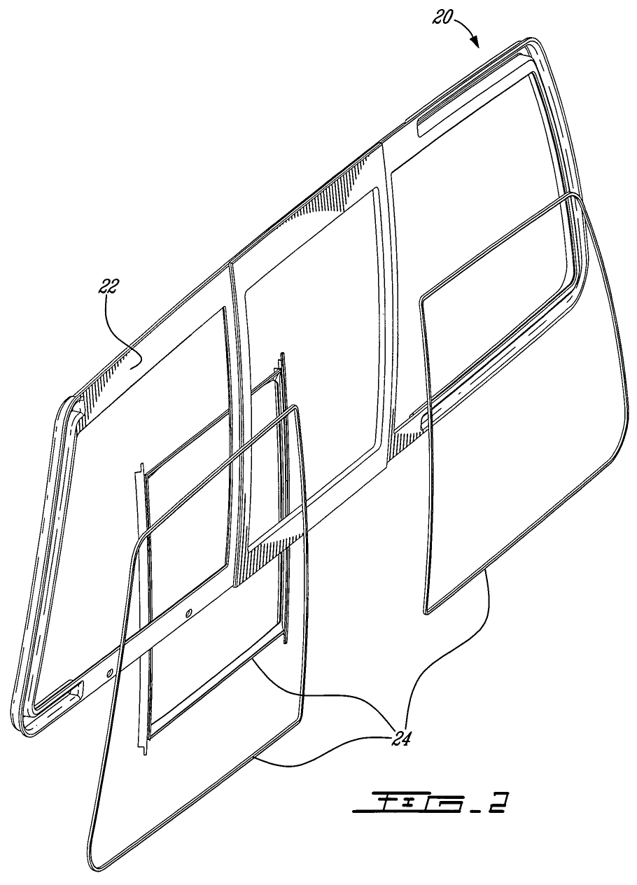

As illustrated in FIG. 2, the resulting one-piece slider frame and seal assembly 20, shown in the case of a slider window assembly with a mobile central window panel in a three-window panel for example, is a one-piece body comprising a core part or frame 22 and sealing components (corresponding to the sheath part) 24.

The slider frame 22 may be made in a glass-filled thermoplastic such as polypropylene (PP). Other materials, such as metal or composites may be used.

The sealing components 24 may be made in a vulcanized TPV (thermoplastic rubber, PP with Ethylene Propylene Diene Monomer EPDM and a coupling agent). Other materials, such as metal or composites may be used.

Step 16 may be performed by vaporizing polytetrafluoroethylene (PTFE) for example. Selecting a sealing components material with intrinsic anti-friction properties in step 14 hereinabove allows avoiding the step 16 of anti-friction treatment of the parts in contact with the mobile window panel mentioned hereinabove.

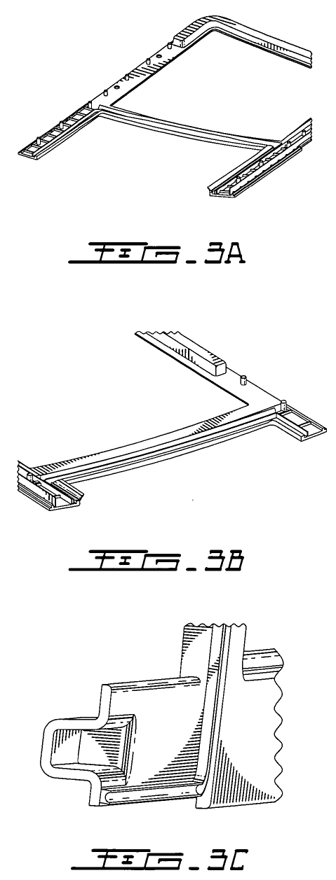

FIGS. 3a and 3b are cross sections of a multi-material molded one-piece slider frame and seal assembly in the case of a slider window assembly for a mobile window panel, showing a dynamic sealing molded onto the frame, which provides a watertight seal for the moving window panel to be installed.

FIG. 3c is a cross section of a multi-material one-piece slider frame and seal assembly for a fixed window panel, showing a static sealing molded onto the frame, which provides a watertight seal for a fixed window panel to be installed.

By multi-material molding, wherein different materials are molded consecutively into a mold cavity, a one-piece slider frame and seal assembly comprising a frame and sealing components of materials with target characteristics is therefore obtained. In contrast to current methods, the present method allows achieving precise geometry of the one-piece slider frame and seal assembly.

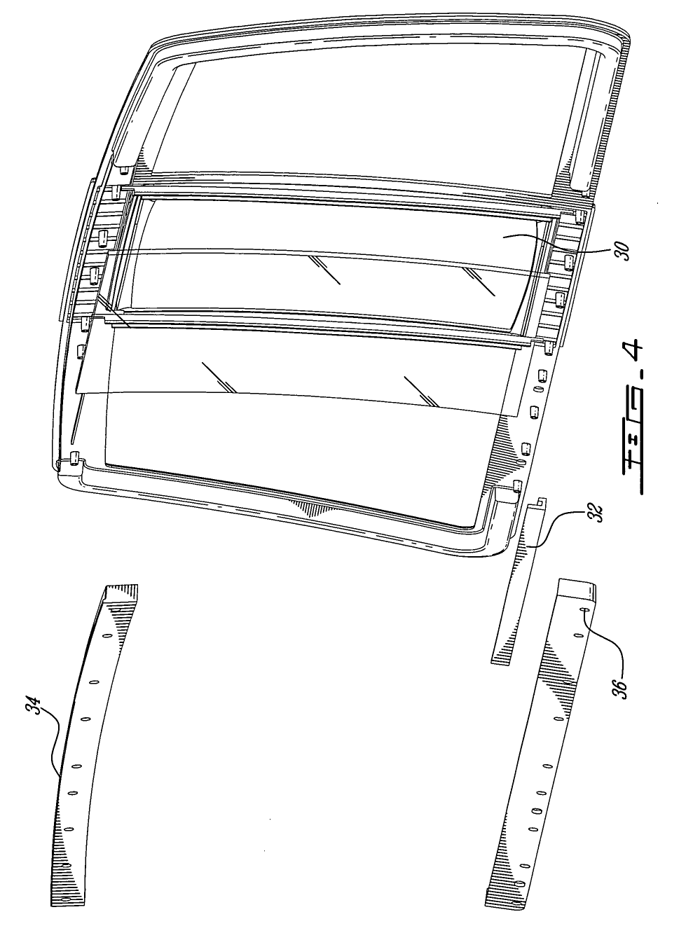

Turning now to FIG. 4, once the slider frame and seal assembly is thus molded, it is assembled with a window panel, which may be a moving center window panel 30 for example. The moving center window panel 30 is itself seated in a window carrier slider 32 that holds the moving window panel 30 on a bottom edge thereof. Top 34 and bottom 36 frame caps are used to maintain the moving center window panel 30 in place and allow a precise and low operating force translation movement thereof. The top cap 34 may comprise a plastic extrusion running channel profile for efficiently securing the window panel 30 and allow smooth movements thereof.

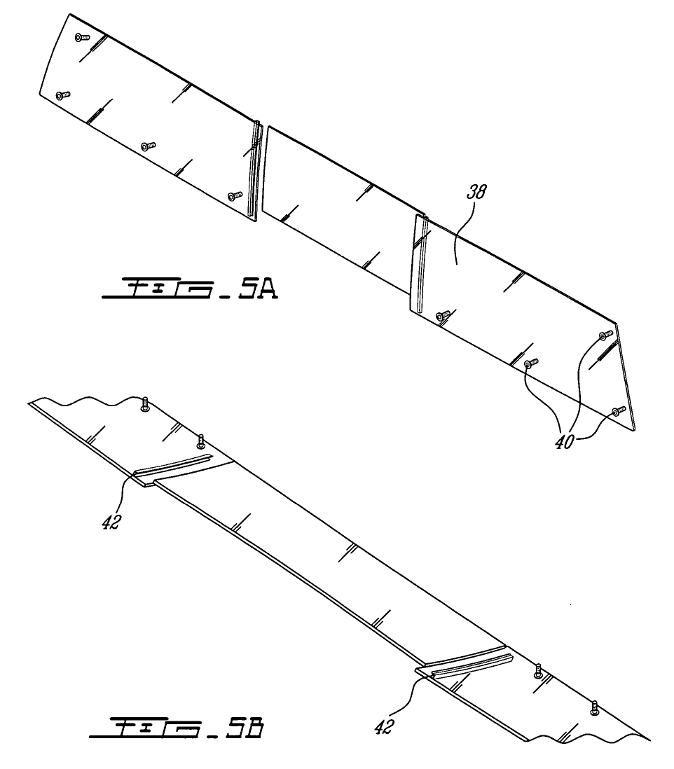

FIG. 5 show details of a slider window assembly with two fixed window panels and a mobile window panel mounted to the one-piece slider frame and seal assembly. The fixed window panel may be a glass panel 38, which is pre-treated with ceramic and has a black contour that is able to withstand adhesion of thermoplastic or metallic components, described hereinafter, on the surface thereof. Moreover, this treated contour may have aesthetic purposes, by preventing the thermoplastic or metallic components to be seen from the outside of the final assembly for example.

The glass panel is pre-assembled with studs 40 and vertical edge tracks 42 mounted on an inner surface thereof, by glue for example. The glass panel is then mounted onto the slider frame, and the studs 40 are secured into holes, provided on the slider frame, by torquing nuts. These holes may be molded as oblong holes and the torque selected so as to allow the resulting assembly to withstand thermal dilatation variation of the slider frame material and of the fixed window panel material, hereby preventing stress that could result in cracks and failures of the slider frame (see FIG. 5a).

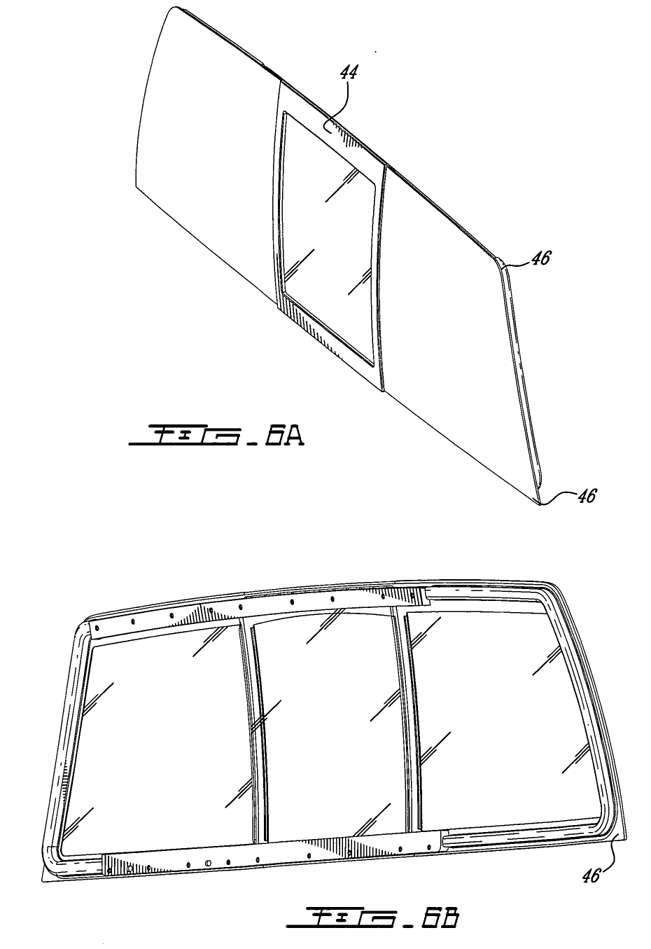

FIG. 6 illustrate a window slider assembly according to an embodiment of the present invention, wherein a section 44 of the center surface contour is highly visible from the outside of the vehicle (not shown). This section 44 may be molded as part of the slider frame. Alternatively, it may be a bezel or a shroud added to the slider frame, thereby allowing model differentiation by varying a color, a texture, and a resin type thereof for example. It is to be noted that the seal body is continuous and precisely fitted even at corners 46.

The present invention provides a slider window assembly by multi-material moulding to yield a slider frame and seal assembly and by mounting a window panel therein.

People in the art will now appreciate that the present provides an improved manufacturing method, which allows using recyclable material both during fabrication and once the multi-material slider frame and seal assembly is worn out. It allows fabricating slider window assemblies with enhanced sealing properties at a decreased production cost. Moreover, it allows product differentiation, compared to actual slider seals that are usually black, by allowing variation of colors, textures or other visual aesthetic surfaces of parts thereof.

From the foregoing, people in the art will appreciate that the present invention provides a slider window assembly and a method for fabrication thereof, allowing an increased fabrication precision and therefore an improved water-tightness.

Although the present invention has been described hereinabove by way of embodiments thereof, it may be modified, without departing from the nature and teachings of the subject invention as described herein.

1. A method for fabricating a window slider assembly, comprising the steps of:
molding a slider frame;
molding slider sealing components about the slider frame to yield a one-piece multi-material slider frame and seal assembly; and
assembling a window panel to the one-piece slider frame and seal assembly.

2. The method according to claim 1, wherein said step of molding the slider frame comprises molding a first material and said step of molding the slider sealing components comprises molding a second material.

3. The method according to claim 2, wherein said step of molding the slider frame comprises molding glass-filled thermoplastic, and said step of molding the slider sealing components comprises molding a vulcanized TPV.

4. The method according to claim 3, wherein said step of molding the slider frame comprises molding polypropylene (PP), and said step of molding the slider sealing components comprises molding a thermoplastic rubber, PP with Ethylene Propylene Diene Monomer EPDM and a coupling agent.

5. The method according to claim 1, wherein said step of molding the slider sealing components comprises selecting a components material with intrinsic anti-friction properties.

6. The method according to claim 1, further comprising the step of submitting surfaces of the slider sealing components to an anti-friction treatment.

7. The method according to claim 5, wherein said step of submitting the surfaces of the slider sealing components to an anti-friction treatment comprises vaporizing polytetrafluoroethylene (PTFE) on the surfaces.

8. The method according to claim 1, wherein said step of assembling the window panel to the one-piece slider frame and seal assembly comprises mounting studs onto edges of the window panel, the studs allowing securing the window panel to holes of the slider frame by means of torquing nuts.

9. The method according to claim 8, the studs being secured into oblong holes of the slider frame by the torquing nuts, thereby accommodating stress due to thermal dilatation variation of materials of the slider frame and seal assembly and of the window panel.

10. The method according to claim 8, wherein the window panel is a fixed window panel, said step of assembling the window panel to the one-piece slider frame and seal assembly comprising mounting vertical edge tracks to the fixed window panel.

11. The method according to claim 1, wherein the window panel is a mobile window panel, said mobile window panel being secured on a bottom edge thereof by a window carrier slider, said step of assembling the window panel to the one-piece slider frame and seal assembly comprising using frame caps to maintain the mobile window panel in place and allow a precise and low operating force sliding movement thereof.

12. The method according to claim 11, top caps of the frame caps comprising a running channel profile.

13. A window slider assembly slider seal assembly comprising a one-piece slider frame and seal assembly and a window panel mounted therein, said one-piece slider frame and seal assembly comprising a slider frame and slider sealing parts molded in a multi-material mold, said slider frame being molded in a first material and said slider sealing parts being molded in a second material, said slider frame and seal assembly receiving at least one of a moving and a fixed window panel.
